(19) United States
(12) Patent Application Publication
(10) Pub. No.: US 2015/0247614 A1
(43) Pub. Date: Sep. 3, 2015

(54) THEATRICAL APPARATUS AND METHOD WITH DIRECT AND INDIRECT PROJECTED LIGHT

(71) Applicants: Richard S. Belliveau, Austin, TX (US); Larry Bernard Roessler, Austin, TX (US)

(72) Inventors: Richard S. Belliveau, Austin, TX (US); Larry Bernard Roessler, Austin, TX (US)

(73) Assignee: BARCO LIGHTING SYSTEMS, INC., AUSTIN, TX (US)

(21) Appl. No.: 14/194,680

(22) Filed: Mar. 1, 2014

(51) Int. Cl. F21V 7/00; H05B 37/02; H05B 33/08; F21V 7/06

(52) U.S. Cl. CPC F21V 7/0016; F21V 7/06; H05B 37/029; H05B 33/0845

(57) ABSTRACT

A theatrical apparatus is disclosed that is comprised of a first method of projecting light and a second method of projecting light. The first method directly projects a first light and the second method indirectly projects a second light. The first light and second light can be independently controlled and combined to produce a third light.

### FIELD OF THE INVENTION

This invention relates to improved methods and apparatus concerning theatrical lighting apparatus and methods.

### BACKGROUND OF THE INVENTION

Multiparameter lighting fixtures are lighting fixtures, which illustratively have two or more individually remotely adjustable parameters such as focus, color, image, position, or other light characteristics. Multiparameter lighting fixtures are widely used in the lighting industry because they facilitate significant reductions in overall lighting system size and permit dynamic changes to the final lighting effect. Applications and events in which multiparameter lighting fixtures are used to great advantage include showrooms, television lighting, stage lighting, architectural lighting, live concerts, and theme parks. Illustrative multi-parameter lighting fixtures are described in the product brochure showing the High End Systems product line for the year 2000 and are available from High End Systems, Inc. of Austin, Tex.

### SUMMARY OF THE INVENTION

In at least one embodiment, a theatrical lighting apparatus is provided comprising a housing, a first light source affixed to the housing, a second light source affixed to the housing, and a reflector. In at least one embodiment, the first light source projects a first light in a first direction; and the second light source projects a second light in a second direction towards the reflector that in turn projects the light in the first direction.

There may be between a ninety to a one hundred and eighty degree difference between the first direction and the second direction. The first light source may substantially conceal the second light source. The first light source may have an intensity and the second light source may have an intensity; wherein the first light source intensity and the second light source intensity can be varied independent of one another.

The apparatus may further include a control circuit within the housing. The first light source intensity and the second light source intensity may be varied by the control circuit and the control circuit may be programmed by a computer program to receive commands from a theatrical controller and to vary the first light source intensity based on one or more commands from the theatrical controller and to vary the second light source intensity based on one or more commands from the theatrical controller.

The control circuit may be programmed to receive commands which include DMX commands, from the theatrical controller and to vary the second light source intensity based on one or more DMX commands and to vary the first light source intensity based on one or more DMX commands.

The first light source may conceal the second light source by coaxial mounting. The first light source may be comprised of a plurality of light sources having different wavelengths.

In at least one embodiment a theatrical lighting apparatus is provided comprising a housing, a first light source affixed to the housing, a second light source affixed to the housing, and a circular reflector. The first light source may project a first light in a first direction. The second light source may project a second light in a second direction towards the circular reflector that in turn projects the light in the first direction. The difference between the first direction and the second direction may be between ninety and one hundred and eighty degrees. The circular reflector may be substantially parabolic and may surround the first light source and the second light source.

One or more embodiments of the present invention may include a method comprising projecting a first light in a first direction from a first light source; and projecting a second light in a second direction from a second light source towards a reflector that in turn projects the light in the first direction.

There may be a ninety to a one hundred and eighty degree difference between the first direction and the second direction; the first light source may substantially conceal the second light source; and the first light source and the second light source may be affixed to a housing of a theatrical lighting apparatus.

The first light source has an intensity and the second light source has an intensity; and the method may further include varying the first light source intensity and the second light source intensity independent of one another. The first light source intensity and the second light source intensity may be varied by a control circuit and wherein the control circuit is programmed by a computer program to receive commands from a theatrical controller and to vary the first light source intensity based on one or more commands from the theatrical controller and to vary the second light source intensity based on one or more commands from the theatrical controller. The control circuit may be programmed to receive commands which include DMX commands, from the theatrical controller and to vary the second light source intensity based on one or more DMX commands and to vary the first light source intensity based on one or more DMX commands.

The first light source may conceal the second light source by coaxial mounting. The first light source may be comprised of a plurality of light sources having different wavelengths.

In another embodiment, a method is further provided including projecting a first light in a first direction from a first light source; and projecting a second light in a second direction towards a circular reflector that in turn projects the light in the first direction; wherein the difference between the first direction and the second direction is between ninety and one hundred and eighty degrees; and wherein the first light source and the second light source are affixed to a housing of a theatrical lighting apparatus. The circular reflector may be substantially parabolic and surround the first light source and the second light source.

### BRIEF DESCRIPTION OF THE DRAWINGS

FIG. 1 shows a simplified diagram of a theatrical lighting apparatus in accordance with an embodiment of the present invention;

FIG. 2 shows a simplified block diagram of an electronic circuit, and a side view of a reflector, first and second light sources, and a theatrical controller; and

FIG. 3 shows a front view of a housing, a reflector the second light source referred to in FIG. 2.

### DETAILED DESCRIPTION OF THE DRAWINGS

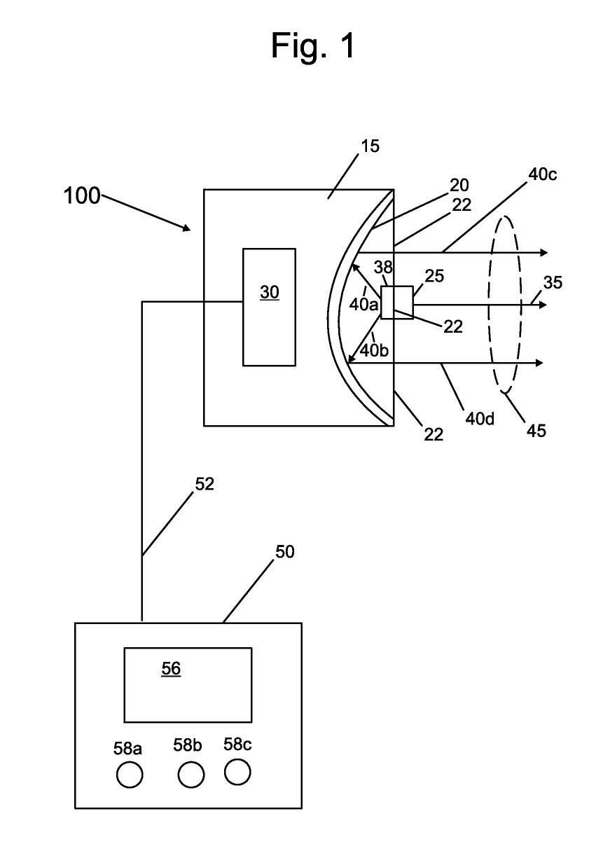

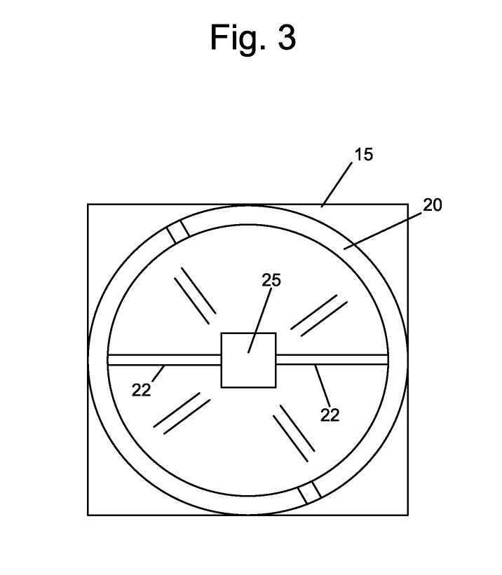

FIG. 1 shows a simplified diagram of a theatrical lighting apparatus 100. The apparatus 100 has a housing 15 wherein a reflector 20 is fixed to the housing 15. The reflector 20 shown can be a spherical reflector manufactured from aluminum or other reflective surfaces. The reflector 20 can have a matte finish or be textured to diffuse light. The reflector 20 may be spherical, parabolic, ellipsoidal or any other shape. The reflector 20 may also be a plurality of segments. In a preferred embodiment of the present invention the reflector 20 is a circular dish as shown by combination of FIG. 1 and FIG. 3, and the reflector 20 and spans around the lights sources 25 and 38. A narrow cross member 22 shown by FIG. 1 and FIG. 3, is fixed across the reflector 20. The cross member 22 is shown as a narrow strip, such as a metal strip, but alternatively may be a thin circular member across the entire face of the reflector 20 shown in FIG. 3. The cross member 22 can be manufactured from a transparent material such as acrylic or glass. The cross member 22 can also be a metal wire or thin strip of metal or plastic. In at least one embodiment, light source 25 is mounted on top of the member 22, and light source 38 is mounted behind the cross member 22 as shown in FIG. 1.

The theatrical lighting apparatus 100 includes a light source 25 which may be a plurality of light sources such as a plurality of LEDs (light emitting diodes) that may be comprised of various visible wavelengths to mix colors as known in the art. The light source 25 directly projects light in the direction of the arrow 35. A second light source 38 may also be provided, which may also be a plurality of light sources such as a plurality of LEDs that are comprised of various visible wavelengths to mix colors as known in the art. The light source 38 projects light in the directions of arrows 40a and 40b. Light in the direction of arrow 40a is reflected by the reflector 20 in the direction of arrow 40c. Light in the direction of arrow 40b is reflected by the reflector 20 in the direction of arrow 40d. Arrows 40c, 40d, and 35 show that light is traveling in the same direction and are combined as a single projected light 45.

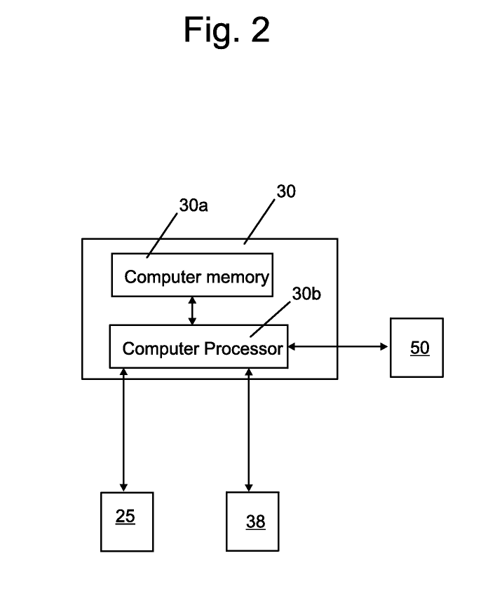

The theatrical apparatus 100 also is comprised of an electronic circuit 30. The electronic circuit 30 can separately vary the intensity of the light source 25 and the light source 38. The electronic circuit 30 may include a computer memory 30a and a computer processor 30b as shown in FIG. 2. The electronic circuit may be programmed by a computer program, stored in the computer memory 30a to vary the intensity of the light source 25 and the light source 38. The electronic circuit 30 also receives digital command signals from a theatrical controller 50 over signal wire 52. The digital command signals can be DMX512 command signals, where DMX512, or digital multiplex 512, is a standard for digital communications networks frequently employed for controlling stage lighting and effects. (See also http://en.wikipedia.org/wiki/DMX512).

The electronic circuit 30 acts in response to the digital command signals to separately vary the intensity of the light source 25 and light source 38 and the corresponding light, including light shown by arrow 35 projected from light source 25, light shown by arrow 40a projected from light source 38, and light shown by arrow 40b projected from light source 38. The theatrical controller 50 is comprised of a video screen 56 and input knobs 58a, 58b and 58c (shown simplified) so that an operator can enter the desired theatrical cues that control the final overall projected light 45.

In a preferred embodiment the light source 25 is fixed over the top of light source 38 so that light source 38 is substantially concealed by the light source 25 so that an artistically pleasing result is accomplished. Light source 25 is shown mounted coaxially over the light source 38 to assist in the concealment of light source 38.

FIG. 3 shows a front view of the housing 15, the reflector 20, and second light source 25. The reflector 20 may be in the shape of a circular dish as shown by FIG. 1 and FIG. 3.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

We claim:

1. A theatrical lighting apparatus comprising:
a housing;
a first light source affixed to the housing;
a second light source affixed to the housing;
a reflector;
wherein the first light source projects a first light in a first direction;
wherein the second light source projects a second light in a second direction towards the reflector that in turn projects the light in the first direction;
wherein there is between a ninety to a one hundred and eighty degree difference between the first direction and the second direction; and
wherein the first light source substantially conceals the second light source.

2. The theatrical lighting apparatus of claim 1 wherein
the first light source has an intensity and the second light source has an intensity;
and wherein the first light source intensity and the second light source intensity can be varied independent of one another.

3. The theatrical lighting apparatus of claim 2 further comprising
a control circuit within the housing;
and wherein the first light source intensity and the second light source intensity are varied by the control circuit and wherein the control circuit is programmed by a computer program to receive commands from a theatrical controller and to vary the first light source intensity based on one or more commands from the theatrical controller and to vary the second light source intensity based on one or more commands from the theatrical controller.

4. The theatrical lighting apparatus of claim 3
Wherein the control circuit is programmed to receive commands which include DMX commands, from the theatrical controller and to vary the second light source intensity based on one or more DMX commands and to vary the first light source intensity based on one or more DMX commands.

5. The theatrical lighting apparatus of claim 1 wherein
the first light source conceals the second light source by coaxial mounting.

6. The theatrical lighting apparatus of claim 1 wherein
the first light source is comprised of a plurality of light sources having different wavelengths.

7. A theatrical lighting apparatus comprising:
a housing
a first light source affixed to the housing;
a second light source affixed to the housing;
a circular reflector; and
wherein the first light source projects a first light in a first direction;
wherein a second light source projects a second light in a second direction towards the circular reflector that in turn projects the light in the first direction; and
wherein there is between a ninety and one hundred and eighty degrees difference between the first direction and the second direction.

8. The theatrical lighting apparatus of claim 2 wherein
the circular reflector is substantially parabolic and surrounds the first light source and the second light source.

9. A method comprising:
projecting a first light in a first direction from a first light source;
projecting a second light in a second direction from a second light source towards a reflector that in turn projects the light in the first direction;
wherein there is between a ninety to a one hundred and eighty degree difference between the first direction and the second direction;
wherein the first light source substantially conceals the second light source; and
wherein the first light source and the second light source are affixed to a housing of a theatrical lighting apparatus.

10. The method of claim 9 wherein
the first light source has an intensity and the second light source has an intensity;
and further comprising varying the first light source intensity and the second light source intensity independent of one another.

11. The method of claim 10 wherein
the first light source intensity and the second light source intensity are varied by a control circuit and wherein the control circuit is programmed by a computer program to receive commands from a theatrical controller and to vary the first light source intensity based on one or more commands from the theatrical controller and to vary the second light source intensity based on one or more commands from the theatrical controller.

12. The method of claim 11 wherein
wherein the control circuit is programmed to receive commands which include DMX commands, from the theatrical controller and to vary the second light source intensity based on one or more DMX commands and to vary the first light source intensity based on one or more DMX commands.

13. The method of claim 9 wherein
the first light source conceals the second light source by coaxial mounting.

14. The method of claim 9 wherein
the first light source is comprised of a plurality of light sources having different wavelengths.

15. A method comprising:
projecting a first light in a first direction from a first light source;
projecting a second light in a second direction towards a circular reflector that in turn projects the light in the first direction;
wherein there is between a ninety and one hundred and eighty degree difference between the first direction and the second direction; and
wherein the first light source and the second light source are affixed to a housing of a theatrical lighting apparatus.

16. The method of claim 15 wherein
the circular reflector is substantially parabolic and surrounds the first light source and the second light source.
